(19) United States
(12) Patent Application Publication
(10) Pub. No.: US 2014/0102311 A1
(43) Pub. Date: Apr. 17, 2014

(54) Popcorn Making Machine with a Sensor for Control of Overloading

(71) Applicant: Mikhail Korin, Moscow (RU)

(72) Inventor: Mikhail Korin, Moscow (RU)

(21) Appl. No.: 13/653,605

(22) Filed: Oct. 17, 2012

(51) Int. Cl. A23L 1/18

(52) U.S. Cl. 99/323.7

(57) ABSTRACT

A popcorn making machine includes a case, a roaster mounted therein and provided with a circulated hot airflow, a feeding pipe receiving raw corn and delivering it into the roaster, a dosage unit capable of controlling a flow of raw corn into the feeding pipe, a sensor unit that includes a light source capable of irradiating light at least partially directed into the roaster containing a quantity of corn kernels, a sensor capable of producing an electric signal corresponding to a light flow received by the sensor, wherein the light flow particularly depends upon the quantity of corn kernels contained in the roaster, a light-guide for delivering the light flow from the roaster to the sensor, and a programmable electronic module capable of processing the electric signal produced by the sensor, associated with the dosage unit and capable of controlling thereof. Detail design of the sensor unit is also provided.

### FIELD OF THE INVENTION

This invention relates to corn popping machines, particularly to popcorn preparation machines utilizing the continuous popping of corn kernels by means of a hot airflow.

### BACKGROUND OF THE INVENTION

There are known a variety of devices for popcorn processing, for example, the one taught in U.S. Pat. No. 7,024,986 that describes “a popcorn maker including a self-regulating heating unit. The self-regulating heating unit provides a regulated heat to the popcorn maker. The self-regulating heating unit can be configured to maintain a predetermined temperature for the popcorn maker. The predetermined temperature can be adjusted to provide appropriate amount of heat to the popcorn maker for popping a maximum number of corn kernels while limiting the heat from causing damage to heating coils and thermoplastic parts of the popcorn maker. The self-regulating heating unit includes a positive temperature coefficient heater.”

Another U.S. Pat. No. 5,421,253 teaches a ‘convection oven corn popper and method’ that “ . . . is provided to air-pop popcorn in combination with a convection-type oven. The device comprises a spring-mounted bowl to hold corn kernels and includes a slot in the sidewall for popped popcorn to exit therefrom. The exiting popcorn falls into the cooking case of the oven where it is held warm until ready to eat.”

“A portable heat-concentrating kettle cooker” is taught in U.S. Pat. No. 6,234,064, in particular, having “a housing with a burner supported within the housing and a kettle carrier pivotably attached to a top edge of the housing such that it can be pivoted from a substantially horizontal position across the top of the housing to a substantially vertical position. The kettle carrier includes a cooking kettle that is positioned over the burner when the kettle carrier is in its substantially horizontal position, and when the kettle carrier is in its substantially vertical position, the cooker kettle is positioned to empty its contents into a tub that is supported next to the housing by a detachable frame extending from the housing. Additional features of the cooker include a heat intensification case formed by a wall around the burner in order to redirect radiant energy from the burner back into the heat intensification case. A cooking oil receptacle is also detachably mounted to the housing. Fuel supplied to the heater can be natural gas, propane, or electricity, with fuel supply lines passing through a fuel supply/control case at the front of the housing and fuel regulating controls positioned on the front of the housing.”

U.S. Pat. No. 6,187,353 to Wyman et al teaches “a hot air popcorn machine including a programmable control system for precisely controlling various operating parameters including air flow and air temperature to enable the machine to consistently produce high quality popcorn in a low maintenance environment, e.g., a free-standing vending machine.” In Wyman's machine, hot airflow comes through the kernels and exits the cooking case, i.e. the hot airflow is not confined in the machine. This leads to over-drying popcorn and overpaying for electric power.

U.S. Pat. No. 6,460,451 to Helman et al discloses “A popcorn maker, which utilizes a combination of popping means, and converts corn kernels to popped corn quicker, more efficiently, and with improved taste. The popcorn maker uses a combination of roasting, agitation, heating, and convection to convert the corn kernels into the popcorn, and expel the popcorn out of the popcorn maker. The popcorn maker is easy to use, the corn kernels and the popcorn easily viewable and fun to watch during popping, the popcorn maker producing the popcorn in a quick, convenient, and efficient manner. The popcorn maker discharges the popcorn from a convenient discharge chute into a receptacle of choice, resembles, and has the appearance of an old fashioned popcorn maker. The popcorn maker is free standing, easy to clean and maintain, and of long lasting, durable material. The popcorn maker is light weight, inexpensive, safe to use, attractive, sturdy, of simple construction, and is easy to store.” In Helman's popcorn maker, hot airflow also comes through the kernels and exits the roaster, i.e. the hot airflow is not confined in the machine. This leads to over-drying popcorn and overpaying for electric power.

U.S. Pat. No. 4,727,798 issued to Nakamura (herein further called ‘Nakamura’) discloses a “popcorn processing machine has a heating case into which a measured quantity of raw corn kernels are fed in each operational cycle to be heated, agitated, and thus popped by only a hot air supplied under pressure as a whirling rising vortex, without the use of an oil, whereby greatly expanded puffs of popcorn of uniform quality are produced in a high yield and in a short processing time. The bottom of the heating case can be opened by a simple mechanism, whereby the popped popcorn product can be quickly dumped and the case bottom rapidly reclosed, the operational cycle time thereby being extremely short.”

Designers of popcorn making machines often encounter a common problem particularly described in Nakamura: “In a typical popcorn processing machine known heretofore, a receiving dish or pan into which corn kernels are charged is provided above a heat source. At the bottom of this pan, agitator vanes for rotating along the upper surface of the pan bottom are fixedly supported on a vertical shaft. Accordingly, when the vertical shaft is rotated, the vanes rotate within the pan thereby to agitate the raw corn kernels as they are heated by the heat source, whereby the corn kernels are heated and popped into expanded state to fill the interior of the pan. In such a machine, oil is ordinarily placed in the pan in order to cause the raw corn kernels to pop rapidly. As a consequence of the agitation of the corn kernels, this oil tends to be scattered together with minute particles of the corn against the inner surface of a transparent cover installed for observation around the sides of the pan. The oil and corn particles thus adhere to the glass cover, thereby dirtying the glass and causing it to become opaque. Furthermore, if these contaminants are left in adhering state, they will attract undesirable insects such as cockroaches and are therefore very unhygienic. Since an opaque condition of the glass cover prevents or obstructs observation of the corn popping progress, the contaminants must be frequently wiped off by hand, which is an inconvenient task. However, if oil is not used in order to prevent this contamination, the time for popping the raw corn becomes disadvantageously long. Furthermore, the construction of the machine itself in this case has been complicated because of the necessity of providing rotational support means and driving means for the agitator vanes.”

As shown above, Nakamura solves this problem by supplying “a hot air supplied under pressure as a whirling rising vortex, without the use of an oil” into the heating case with an openable bottom for popping. Thereafter, “the popped popcorn product can be quickly dumped and the case bottom rapidly reclosed, the operational cycle time thereby being extremely short.” However, the “whirling rising vortex” conditions an increased density of kernels in the lower central region of the case, wherein the speed of kernels and temperature of hot air are essentially minimal, which leads to uneven heating the kernels located in this region that slows down the overall heating of corn kernels in the case thereby decelerating the whole process of popcorn preparation. Besides, the movable bottom of the heating case reduces the overall reliability and maintainability of the Nakamura's machine.

The aforementioned shortage of Nakamura's machine was addressed in U.S. patent application Ser. No. 12/592,106 filed on 18 Nov. 2009 by Mikhail Korin, the instant inventor, now U.S. Pat. No. 8,276,504 issued on 2 Oct. 2012 titled “Hot-air popcorn machine especially with a seasoning coater”, whose disclosure is incorporated herein in its entirety by reference. U.S. Pat. No. 8,276,504 particularly teaches “A popcorn making machine includes a main unit comprising a fan pumping air into a case, enclosing a heater and a bowl. The bowl has sidewalls tapered downwardly with mini-nozzles attached thereto. Hot airflows are introduced from the case through the mini-nozzles into the bowl tangentially to its inner surface, forming a main hot airflow circulation. A central nozzle is mounted at the bowl's bottom, including slots, introducing additional airflows, tangential to the nozzle's surface, from the case into the bowl, forming an additional hot airflow circulation surrounding the nozzle, co-directed with the main circulation . . . ” According to U.S. Pat. No. 8,276,504, the popcorn machine also comprises a feeding pipe through which raw corn is supplied into the bowl. This popcorn making machine is advantageous, since it provides a circulated hot airflow confined within the cooking case, which improves the popcorn preparation process and recycles heat. Nonetheless, exploitation and maintenance of the popcorn machine according to U.S. Pat. No. 8,276,504 have revealed certain inconveniences.

During a stable mode of operation of the machine, the bowl contains a certain amount of corn that depends upon the rate of intake of raw corn kernels into the machine, the temperature in the bowl, and the quality of corn. In the course of popcorn preparation, e.g. due to moisture fluctuations of raw corn (or other reasons), the amount of incoming corn kernels may become greater than the amount of outgoing corn kernels. This can lead to overloading (over-filling) the bowl by corn, blocking the circulation of hot airflow in the machine, causing the overheating thereof, thereby preventing normal operation of the machine that sometimes may cause fire of corn kernels in the bowl.

### BRIEF SUMMARY OF THE INVENTION

A primary aim of the claimed invention is to provide a simply designed hot-air popcorn making machine, enabling a fast and essentially even heating of corn kernels for efficient popping up thereof, and, at the same time, solving the above-described problem of clogging the popcorn making machine.

Another aim of the claimed invention is to enhance the overall reliability and maintainability of the popcorn machine taught in to U.S. Pat. No. 8,276,504.

Another aim of the claimed invention is to utilize optional embodiments of the popcorn making machine, according to U.S. Pat. No. 8,276,504, including the employment of a coater unit for coating the popped corn with oil, salt, etc.

Other aims and particular applications of the claimed invention may become apparent to one skilled in the art upon learning the present disclosure.

These aims are achieved by providing a popcorn making machine, in a preferred embodiment, comprising: a case; a roaster mounted within the case, wherein a circulated hot airflow is provided in the roaster; a feeding pipe communicating with the case and providing intake of raw corn into the roaster; a dosage unit capable of permitting, or prohibiting, or changing a flow of raw corn into the feeding pipe; a sensor unit including: a light source capable of irradiating light at least partially directed into the roaster containing a quantity of corn kernels; a sensor capable of producing an electric signal corresponding to a light flow received by the sensor, wherein the light flow particularly depends upon the quantity of corn kernels contained in the roaster; a light-guide for delivering the light flow from the roaster to the sensor; and a programmable electronic module capable of processing the electric signal produced by the sensor, wherein the electronic module is associated with the dosage unit and capable of controlling thereof.

### BRIEF DESCRIPTION OF DRAWINGS

FIG. 1 shows a sectional front view of the popcorn making machine, according a preferred embodiment of the claimed invention.

FIG. 2 shows a fragmental sectional view of the embodiment of the popcorn making machine, according the claimed invention, depicted on FIG. 1.

FIG. 3 shows a sectional plan view of a roaster of the popcorn making machine along a view direction ‘A’ shown on FIG. 2, according to a preferred embodiment of the claimed invention.

FIG. 4 shows a sectional view of an inventive sensor unit of the popcorn making machine, according to a preferred embodiment of the claimed invention.

FIG. 5 shows a schematic view of functional relations of the sensor unit with other units of the popcorn making machine, according to a preferred embodiment of the claimed invention.

### DETAIL DESCRIPTION OF PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

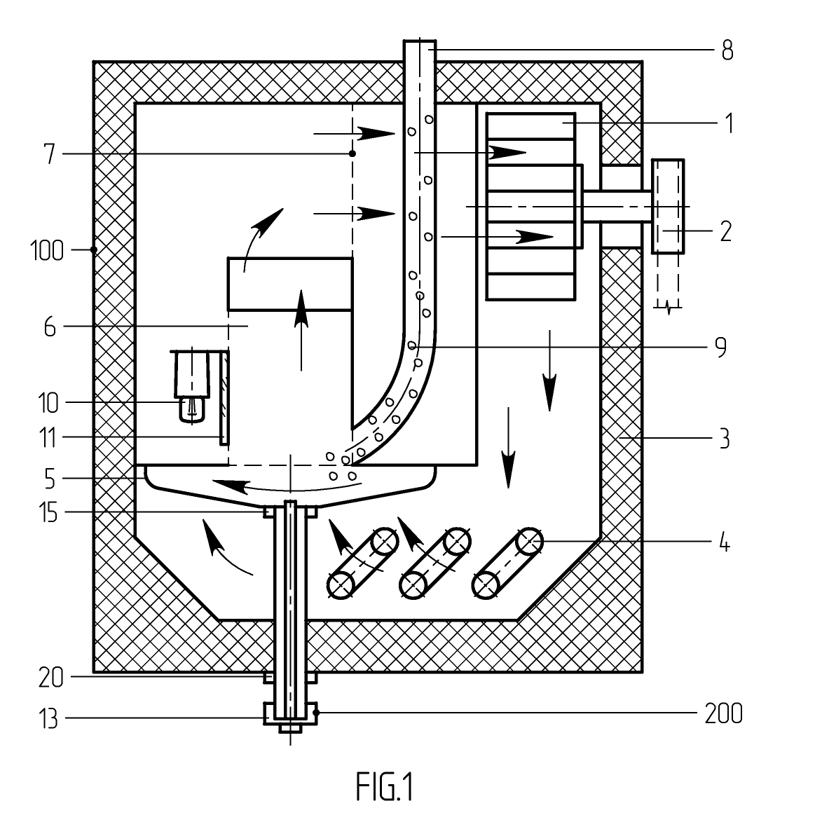

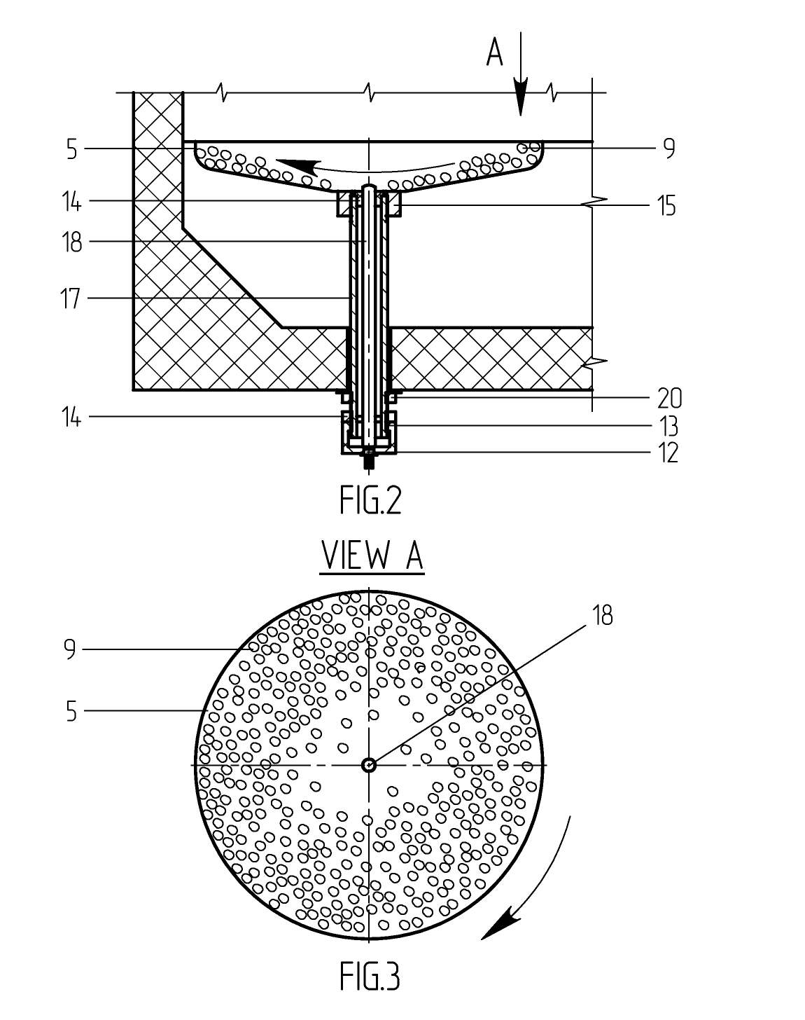

In preferred a embodiment, illustrated on FIGS. 1 and 2, the inventive popcorn making machine includes a main unit 100, comprising: a case 3; a fan 1 driven by a drive 2 (that may preferably include an electric motor—not shown, and a transmission, for example, a belt transmission); the fan 1 is capable of pumping air via a net screen 7 out of the case 3 with a bottom, which case 3 encloses a cooking roaster 5 (herein further called ‘roaster’, but can also be called a ‘kettle’ or a ‘cooker’), and a heater 4 that can be represented by any suitable type of conventional heater, preferably an electric coil outwardly surrounding the roaster's sidewalls (as shown on FIG. 1), and powered preferably from a suitable electrical source (not shown herein), preferably supplying controllable voltage. The heater 4 is preferably mounted at the case's bottom, beneath the roaster 5.

The main unit 100 comprises a pipebranch 6 consisting of a first inclined branch receiving popped-up corn kernels from the cooking roaster 5, and a second inclined branch in a ‘knee’-manner joined with the first inclined branch, through which second inclined branch the popped-up corn kernels are discharged (not shown herein) from the main unit 100. The net screen 7 prevents getting the popped corn kernels to the fan 1 and returns them into the pipebranch 6.

The roaster 5 has a bottom, and sidewalls that can be tapered downwardly (i.e. shaped as a bowl, similar to that described in U.S. Pat. No. 8,276,504), or the sidewalls can have a different suitable shape. The sidewalls are preferably furnished with mini-nozzles (not shown herein) attached to the internal surface of sidewalls. The mini-nozzles can be attached to the bottom of roaster 5 as well. The mini-nozzles may have a shape described in U.S. Pat. No. 8,276,504, or another similar shape, suitable for creation of a circulated hot airflow within the roaster 5. Thusly, hot airflows are introduced from the case 3, preferably through the mini-nozzles, into the roaster 5 tangentially to the inner surface of its sidewalls, thereby forming a hot airflow circulation within the roaster 5. Raw corn kernels, affected by the hot airflow circulation, are heated up faster and evenly. Optionally, the hot airflow circulation can be provided not necessarily by mini-nozzles, but by other suitable means capable of creating such hot airflow circulation.

As it mentioned above, in a stable (normal) operation mode, the roaster contains a certain quantity of corn that depends upon the intake rate of raw corn kernels into the machine, the temperature in the roaster, and the conditions (quality, moisture, etc.) of corn. In the course of popcorn preparation, e.g. due to moisture fluctuations of raw corn (or other reasons), the quantity of incoming corn kernels may become greater than the quantity of outgoing corn kernels. This can lead to overloading (over-filling) the roaster by corn, blocking the circulation of hot airflow in the machine, causing the overheating thereof, thereby preventing normal operation of the machine that sometimes may cause fire of corn kernels in the roaster. This problem has been solved by the present invention, particularly by imparting a sensor unit into the popcorn making machine, as described below.

The main unit 100 comprises a dosage unit 26 capable of controlling (permitting, prohibiting, or changing) a flow of raw corn kernels 9 supplying the popcorn making machine. The dosage unit 26 may also be capable of initializing an alarm signal, e.g. when or before it reduces or shuts off the supply of raw corn into the popcorn making machine. The type of dosage unit 26 can be chosen from known dosage devices capable of providing the aforementioned functions. The main unit 100 comprises a feeding pipe 8, receiving raw corn kernels 9 from the dosage unit 26, if it permits the intake of raw corn kernels, and further conducting the flow of raw corn kernels into the roaster 5. The feeding pipe 8 is mounted, preferably vertically, essentially on top of the case 3.

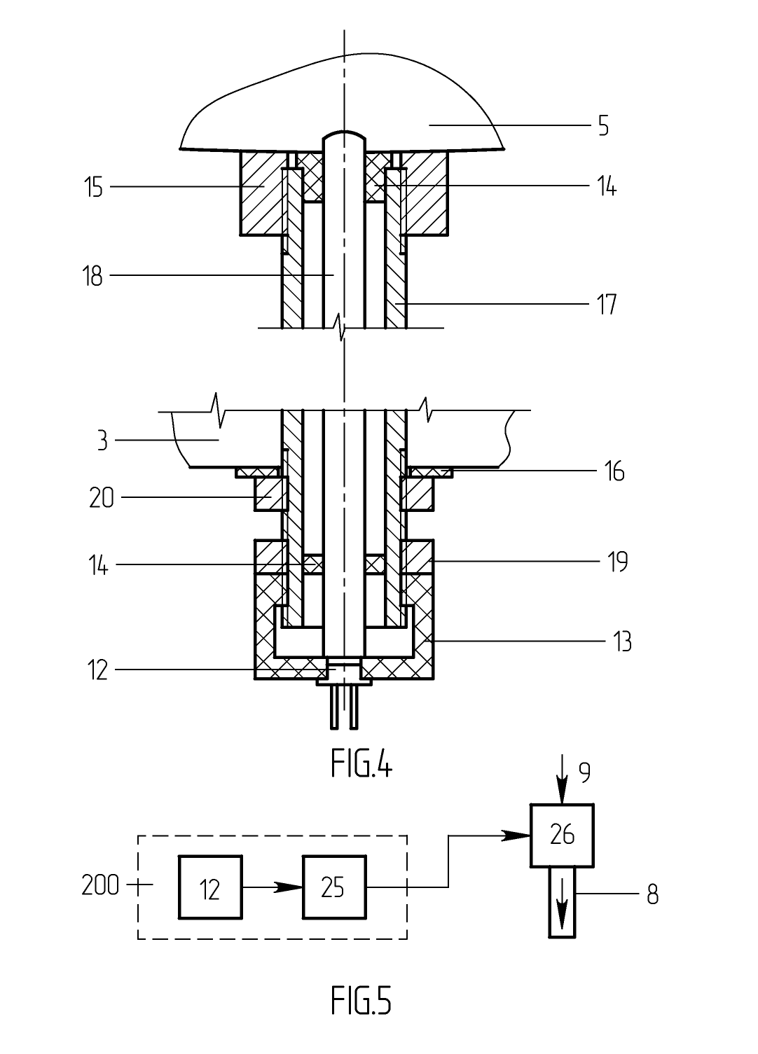

In preferred embodiment, the main unit 100 comprises a sensor unit 200 (shown on FIG. 1, and its elements are shown on FIGS. 2-5) capable of controlling the dosage unit 26. The sensor unit 200 includes: a photo-optical sensor 12 (herein further called ‘sensor’); a light source 10 preferably furnished with a window 11 for directing the light irradiated by the light source 10 into the pipebranch 6, and partially into the roaster 5; a light-conducting light-guide 18 for delivering light from the roaster 5 to the sensor 12; and a programmable electronic module 25 capable of processing an electric signal outputted from the sensor 12, wherein the electronic module 25 is associated with the dosage unit 26 and capable of controlling thereof.

The sensor 12 can be represented by a photo-diode, a photo-resistor, or another photo device suitable of converting a light intenseness signal into an electric signal. The sensor 12 is mounted outside the case 3 (as shown on FIG. 2) to protect it from a comparatively high temperature taking place in the case 3 during operation of the popcorn making machine.

The light source 10 can be represented by a regular incandesced bulb, or another suitable light-producing device. The light source 10 is mounted inside the case 3, but outside of the roaster 5 and the pipebranch 6. The window 11 is preferably made of glass capable of sustaining the high temperature taking place inside the pipebranch 6 and the roaster 5 during operation of the machine. Light, produced by the light source 10, delivered via the window 11 into the pipebranch 6, reflected from the walls of pipebranch 6, and dissipated in the roaster 5, creates a certain level of illuminance in the roaster 5, depending on the quantity of corn kernels currently contained in the roaster 5.

The light-guide 18 can be represented by a light-conducting rod made of quartz glass having a top end located above the bottom of roaster 5 inside thereof, a bottom end located outside the case 3, and outer sidewalls. The light-guide 18 is protected by a cover tube 17 (preferably made of a suitable type of steel). The light-guide 18 is mounted within the cover tube 17 separated by a number of thermo-insulative bushings 14 (typically, a pair of bushings 14—an upper bushing and a lower bushing—should be enough, shown on FIG. 2) inserted between the inner sidewalls of cover tube 17 and the outer sidewalls of light-guide 18, such that the light-guide 18 is capable of vertical movements inside the immovable cover tube 17. The bushing 14 can preferably be made of a suitable type of thermo-resistive plastic or rubber.

The cover tube 17 has an upper nut 15 externally fixed (preferably welded) to the outer sidewalls of cover tube 17 in an upper portion thereof, and externally fixed (preferably welded) to the bottom of roaster 5. The cover tube 17 has a lower nut 20 externally fixed (preferably welded) to the outer sidewalls of cover tube 17 in a lower portion thereof. The lower nut 20 is secured to the bottom of case 3 via a suitable washer (gasket) 16. The lower nut 20 and the washer 16 provide for air-tightness (hermetic connection) of the case 3.

The bottom end of light-guide 18 is supported by a housing 13, preferably having a cylindrical shape with an upper opening and a circular bottom with an orifice made therein. The sensor 12 is at least partially inserted in the orifice, such that the sensor 12 is coupled with the bottom end of light-guide 18, preferably at the circular bottom of housing 13. The housing 13 is furnished with an inner threading made in the upper portion thereof, while the cover tube 17 is furnished with an outer threading made on the outer sidewalls, in the lower portion thereof. This allows the housing 13 to be screwed on the cover tube 17, which provides for vertical movements of the housing 13 in relation to the cover tube 17 that, in turn, allows for vertical movements of the light-guide 18 in and out of the roaster 5, thereby adjusting the sensitivity of sensor unit 200 to a level predetermined by the user. In order to provide a tight fixation of the housing 13 on the cover tube 17, a counter-nut 19 with an inner threading is placed on the outer treading of cover tube 17, such that the pair of cover tube 17 and counter-nut 19 fixes the light-guide 18 at a desirable point to avoid unwanted movements (e.g. caused by vibrations) of the housing 13. The housing 13 can preferably be made of a suitable type of thermo-resistive and thermo-insulative plastic to reduce a heat outflow from the case 3 to the sensor 12.

The electronic module 25 typically has options for adjusting the sensitivity of sensor 12 regarding the level of light flow for triggering operation modes of the popcorn making machine, as well as for presetting a time period for delay (‘delay time period’) of triggering the operation modes. The delay time period is necessary, since corn kernels pop up chaotically and may briefly shut the light flow that should not prevent the normal operation of the machine.

### Operation of Preferred Embodiments

In preferred embodiments, the inventive popcorn making machine operates as follows. FIG. 3 shows a sectional view illustrating the distribution of corn kernels 9 inside the roaster 5 in a normal operation mode (typically, the density of corn kernels is higher in the peripheral locations than in the center); the hot airflow circulation is indicated by an arrow. The light-guide 18 conducts the light flow from the interior of roaster 5 to the sensor 12 that produces an electric signal of a level depending upon the light intenseness (illuminance) inside the roaster 5. The electronic module 25 receives the electric signal produced by the sensor 12, filters and processes this signal, comparing it with an ‘alarm’ signal level (‘alarm threshold’) pre-set programmably or by the user, or with a ‘reduce-rate’ signal level (‘reduce-rate threshold’) pre-set programmably or by the user, or with a ‘shutoff’ signal level (‘shutoff threshold’) pre-set programmably or by the user.

When the signal doesn't exceed the alarm threshold (in the normal operation mode, wherein corn kernels don't essentially shadow the light flow from the roaster 5 into the light-guide 18), the electronic module sends a control command to the dosage unit 26 instructing it of permitting raw corn kernels to get into the feeding pipe 8.

When the signal exceeds the alarm threshold (in an alarm operation mode, when the quantity of corn kernels is getting higher in the roaster 5, and the light flow is partially shadowed), the electronic module 25 sends a control command to the dosage unit 26 instructing it of initializing an alarm signal, such that the user may have an opportunity to manually adjust the intake rate of raw corn kernels into the machine.

When the signal exceeds the reduce-rate threshold (in a reduce-rate operation mode, when the quantity of corn kernels is essentially higher than the normal one in the roaster 5, and the light flow is significantly shadowed by corn kernels inside the roaster 5), the electronic module 25 sends a control command to the dosage unit 26 instructing it of reducing the intake rate of raw corn kernels into the feeding pipe 8. When the quantity of corn kernels in the roaster 5 is normalized, the electronic module 25 can be pre-programmed to change its command to a control command instructing the dosage unit 26 of permitting raw corn kernels to get into the feeding pipe 8 with a normal intake rate (i.e. effectively, increasing the intake rate to the normal one).

When the signal exceeds the shutoff threshold (in a shutoff operation mode, when the quantity of corn kernels is dangerously raising in the roaster 5, and the light flow is essentially shut by corn kernels inside the roaster 5), the electronic module 25, after the end of the delay time period, sends a control command to the dosage unit 26 instructing it of shutting off the raw corn flow into the feeding pipe 8. When the quantity of corn kernels in the roaster 5 is normalized, the electronic module 25 can be pre-programmed to change its command to a control command to the dosage unit 26 instructing it of permitting raw corn kernels to get into the feeding pipe 8 (i.e. effectively restoring the intake of raw corn into the machine).

The inventive popcorn making machine can implement either the alarm operation mode, or the reduce-rate operation mode, or the shutoff operation mode, or any combination thereof.

### Optional Ramifications

As it was disclosed in U.S. Pat. No. 8,276,504: “In addition to the main unit 100, a preferred (combined) embodiment of the inventive popcorn making machine . . . may additionally comprise a coater unit . . . The claimed popcorn making machine in alternative embodiments may comprise only the above described main unit 100 without any coater unit.” Likewise, the main unit 100 of the instant invention can also be optionally combined with the coater unit described in U.S. Pat. No. 8,276,504.

I claim:

1. A popcorn making machine comprising:
a case,
a roaster mounted within said case, wherein a circulated hot airflow is provided in the roaster;
a feeding pipe communicating with said case and providing intake of a flow of raw corn into said roaster;
a dosage unit capable of permitting, or prohibiting, or changing a rate of said flow of raw corn into the feeding pipe;
a sensor unit including:
a light source capable of irradiating light at least partially directed into the roaster containing a quantity of corn kernels;
a sensor capable of producing an electric signal corresponding to a light flow received by the sensor from the light source, wherein said light flow particularly depends upon the quantity of corn kernels contained in the roaster;
a light-guide for delivering said light flow from the roaster to the sensor; and
a programmable electronic module capable of processing said electric signal produced by the sensor, wherein said electronic module is associated with the dosage unit and capable of controlling thereof according to the quantity of corn kernels contained in the roaster.

2. The popcorn making machine according to claim 1, wherein
said roaster has a bottom; said light-guide is represented by a light-conducting rod having outer sidewalls, a top end located above the bottom of said roaster inside thereof, and a bottom end located outside the case; said sensor unit further includes:
a cover tube having inner sidewalls and outer sidewalls, said light-guide is mounted in the cover tube separated by a number of thermo-insulative bushings inserted between the inner sidewalls of said cover tube and the outer sidewalls of said light-guide, such that the light-guide is capable of vertical movements inside the cover tube; the cover tube has an upper nut externally fixed to the outer sidewalls of said cover tube in an upper portion thereof, and externally fixed to the bottom of said roaster; the cover tube has a lower nut externally fixed to the outer sidewalls of said cover tube in a lower portion thereof; the lower nut is secured to the bottom of said case via a washer; and
a housing having an upper opening enclosing the bottom end of said light-guide, and a bottom with an orifice, wherein said sensor is at least partially inserted in the orifice, such that the sensor is coupled with the bottom end of said light-guide; the housing has an upper portion, the housing is furnished with an inner threading made in the upper portion thereof, whereas the cover tube has a lower portion, the cover tube is furnished with an outer threading in the lower portion thereof, thereby allowing said outer threading to screw on said inner threading and providing for vertical movements of said housing in relation to the cover tube that allows for vertical movements of the light-guide in and out of the roaster, thereby adjusting sensitivity of said sensor unit to a predetermined level.

3. The popcorn making machine according to claim 2, wherein said sensor unit further includes:
a counter-nut placed on the outer treading of said cover tube, such that the cover tube and the counter-nut form a pair providing for fixing the light-guide at a desirable point to avoid unwanted movements of the housing.

4. A popcorn making machine comprising:
a case,
a roaster mounted within said heating case, wherein a circulated hot airflow is provided in the roaster; said roaster is supplied with raw corn kernels;
a sensor unit including:
a light source capable of irradiating light at least partially directed into the roaster containing a quantity of corn kernels;
a sensor capable of producing an electric signal corresponding to a light flow received by the sensor from the light source, wherein said light flow particularly depends upon the quantity of corn kernels contained in the roaster;
a light-conducting light-guide for delivering said light flow from the roaster to the sensor; and
a programmable electronic module capable of processing the electric signal received from the sensor and producing a signal capable of controlling supply of raw corns into said roaster according to the quantity of corn kernels contained in the roaster.

5. The popcorn making machine according to claim 4, wherein
said roaster has a bottom; said light-guide is represented by a light-conducting rod having outer sidewalls, a top end located above the bottom of said roaster inside thereof, and a bottom end located outside the case; said sensor unit further includes:
a cover tube having inner sidewalls and outer sidewalls, said light-guide is mounted in the cover tube separated by a number of thermo-insulative bushings inserted between the inner sidewalls of said cover tube and the outer sidewalls of said light-guide, such that the light-guide is capable of vertical movements inside the cover tube; the cover tube has an upper nut externally fixed to the outer sidewalls of said cover tube in an upper portion thereof, and externally fixed to the bottom of said roaster; the cover tube has a lower nut externally fixed to the outer sidewalls of said cover tube in a lower portion thereof; the lower nut is secured to the bottom of said case via a washer; and
a housing having an upper opening enclosing the bottom end of said light-guide, and a bottom with an orifice, wherein said sensor is at least partially inserted in the orifice, such that the sensor is coupled with the bottom end of said light-guide; the housing has an upper portion, the housing is furnished with an inner threading made in the upper portion thereof, whereas the cover tube has a lower portion, the cover tube is furnished with an outer threading in the lower portion thereof, thereby allowing said outer threading to screw on said inner threading and providing for vertical movements of said housing in relation to the cover tube that allows for vertical movements of the light-guide in and out of the roaster, thereby adjusting sensitivity of said sensor unit to a predetermined level.

6. The popcorn making machine according to claim 5, wherein said sensor unit further includes:
a counter-nut placed on the outer treading of said cover tube, such that the cover tube and the counter-nut form a pair providing for fixing the light-guide at a desirable point to avoid unwanted movements of the housing.
